(19) United States
(12) Patent Application Publication
(10) Pub. No.: US 2016/0103556 A1
(43) Pub. Date: Apr. 14, 2016

(54) DISPLAY APPARATUS AND CONTROL METHOD THEREOF

(71) Applicant: SAMSUNG ELECTRONICS CO., LTD., Suwon-si (KR)

(72) Inventor: Yong-ku KIM, Seoul (KR)

(21) Appl. No.: 14/878,499

(22) Filed: Oct. 8, 2015

(30) Foreign Application Priority Data
Oct. 14, 2014 (KR) 10-2014-0138386

(51) Int. Cl. G06F 3/041; G09G 3/20; G06F 3/0489; G06F 3/0488; G06F 3/023

(52) U.S. Cl. CPC G06F 3/0418; G06F 3/04883; G06F 3/0414; G06F 3/0238; G06F 3/0489; G09G 3/2003

(57) ABSTRACT

A display apparatus is provided. The display apparatus including a display, a memory configured to store color feedback information for input objects, a user interface configured to receive a user command, and a controller configured to control the display to provide color feedback corresponding to an input object input according to the user command based on the color feedback information stored in the memory in response to the user command being received.

### CROSS-REFERENCE TO RELATED APPLICATION

This application is based on and claims priority under 35 U.S.C. §119 to prior Korean Patent Application No. 10-2014-0138386, filed on Oct. 14, 2014, in the Korean Intellectual Property Office, the disclosure of which is incorporated herein by reference in its entirety.

### BACKGROUND

1. Field

Apparatuses and methods consistent with example embodiments relate to a display apparatus and a control method thereof, and more particularly, to a display apparatus and a control method thereof which are capable of minimizing and/or reducing an input error of a user command.

2. Description of the Related Art

In general, there are a keyboard input methods which are used to input a character by pressing specific keys using a physical keyboard or a virtual keyboard, a handwriting input method which directly writes a character on a touch screen using an input tool or a finger and recognizes the input character, and the like.

In recent display apparatuses such as a smart phone or a tablet personal computer (PC), the handwriting input method using the touch screen, which is capable of forming a large screen through the omission of a keypad in the related Hangul input method using the keypad due to the development of information display and input technology, has been largely used.

The apparatuses using the handwriting input method such as a smart phone or a tablet PC are pen input type apparatuses having a thin liquid crystal display (LCD) which recognize input characters by detecting a position of a digital pen or a finger through an electric signal difference in the touch screen.

However, since the handwriting patterns vary by user and letters having similar shapes or the like are often incorrectly recognized, the accuracy of the handwriting input recognition sufficient to satisfy the users is not ensured.

In the character input method using a keyboard, since special keys having various functions are included in the keyboard, the user may not easily determine which one among the various special keys is activated before the text is input. Therefore, mistyped letters are frequently caused due to the activated special key, and the user must then delete the mistyped letters and retype the correct letters.

Therefore, there is a need for a method capable of inducing correct letter input as intended by the user, thereby improving user satisfaction.

### SUMMARY

Example embodiments described herein may overcome at least some the above disadvantages and other disadvantages not described above.

One or more e embodiments relate to a display apparatus and a control method thereof which are capable of inducing correct letter input by intuitively notifying a user of a recognition state of an input handwriting or an input of a special key through color feedback.

According to an aspect of an exemplary embodiment, there is provided a display apparatus including a display; a memory configured to store color feedback information for input objects; a user interface configured to receive a user command; and a controller configured to control the display to provide color feedback corresponding to an input object input according to the user command based on the color feedback information stored in the memory in response to the user command being received.

The memory may store at least one of color feedback information for letter types and color feedback information for individual letters.

The letter types may include at least one of a capital type, a small letter type, a number type, a special symbol type, and a letter type including double consonants.

In response to a handwriting input being received, the display may display an input handwriting, and the controller may provide color feedback corresponding to a preset letter recognized by the handwriting input onto the displayed handwriting based on the color feedback information stored in the memory.

The controller may provide a color corresponding to the preset letter to the displayed handwriting with a highlighter effect.

The display may display an input window. In response to a preset key being input to the input window, the controller may provide color feedback corresponding to the key input to the input window based on the color feedback information stored in the memory.

The preset key may include at least one among special keys included on a keyboard. The controller may provide color feedback by changing a color of the input window to a color corresponding to the input special key based on color feedback information corresponding to the special keys.

The controller may provide color feedback by changing a color of the input window to a color determined based on a priority set to a plurality of special keys in response to the plurality of special keys being simultaneously input.

The controller may provide color feedback by alternately changing a color of the input window to colors corresponding to a plurality of special keys in response to the plurality of special keys being simultaneously input.

The controller may provide a user interface (UI) for selecting an input object and a feedback color according to an preset event, and store an input object selected on the UI according to the user command and a color corresponding to the selected input object as color feedback information corresponding to the selected input object.

According to an aspect of an example embodiment, there is provided a method of controlling a display apparatus, the method including receiving a user command; and providing color feedback corresponding to a received input object input according to the user command based on color feedback information pre-stored according to input objects.

The color feedback information pre-stored according to the input objects may include at least one of color feedback information for letter types and color feedback information for individual letters.

The letter types may include at least one of a capital type, a small letter type, a number type, a special symbol type, and a letter type including double consonants.

The method may further include displaying a handwriting input according to a received handwritten input. The providing of the color feedback may include providing color feedback corresponding to a preset letter recognized by the handwriting input onto the displayed handwriting based on the pre-stored color feedback information.

Providing color feedback may include providing a color corresponding to the preset letter to the displayed handwriting with a highlighter effect.

The method may further include displaying an input window. Providing color feedback may include, in response to receiving a preset key input to the input window, providing color feedback corresponding to the key input to the input window based on the pre-stored color feedback information.

The preset key may include at least one among special keys included on a keyboard. Providing color feedback may include providing color feedback by changing a color of the input window to a color corresponding to the input special key based on color feedback information corresponding to the special keys.

Providing color feedback may include providing color feedback by changing a color of the input window to a color determined based on a priority set to a plurality of special keys in response to the plurality of special keys being simultaneously input.

Providing color feedback may include providing color feedback by alternately changing a color of the input window to colors corresponding to a plurality of special keys in response to the plurality of special keys being simultaneously input.

The method may further include providing a user interface (UI) for selecting an input object and a feedback color according to an preset event, and storing an input object selected on the UI and a color corresponding to the selected input object as color feedback information corresponding to the selected input object.

According to various exemplary embodiments, the user input error may be minimized and/or reduced by inducing letter input as intended by the user, and user satisfaction may be improved.

Additional aspects and advantages of the example embodiments are set forth in the detailed description, and will be apparent from the detailed description, or may be learned by practicing the example embodiments.

### BRIEF DESCRIPTION OF THE DRAWINGS

The above and/or other aspects will be more apparent from the following detailed description taken in conjunction with the following drawings in which like reference numerals refer to like elements, and wherein:

FIG. 1 is a schematic block diagram illustrating a configuration of a display apparatus according to an example embodiment;

FIGS. 2A and 2B are diagrams illustrating a handwriting input method and a keyboard input method according to an example embodiment;

FIGS. 3A and 3B are diagrams illustrating a method of storing color feedback information for input objects according to an example embodiment;

FIGS. 4A and 4B are diagrams illustrating a process of providing color feedback onto a displayed handwriting according to an example embodiment;

FIG. 5 is a diagram illustrating a method of storing color feedback information for input objects according to another example embodiment;

FIG. 6 is a diagram illustrating a method of providing color feedback onto a displayed input window according to an example embodiment;

FIG. 7 is a detailed block diagram illustrating a configuration of a display apparatus according to another example embodiment;

FIG. 8 is a detailed block diagram illustrating a configuration of a memory according to an example embodiment; and

FIG. 9 is a flowchart illustrating a control method of a display apparatus according to an example embodiment.

### DETAILED DESCRIPTION

Hereinafter, the example embodiments are described in greater detail with reference to the accompanying drawings.

In the following description, unless otherwise described, the same reference numerals are used for the same elements when they are depicted in different drawings. The matters defined in the description, such as detailed construction and elements, are provided to assist in a comprehensive understanding of the example embodiments. Thus, it is understood that the example embodiments can be carried out without those specifically defined matters. Also, functions or elements known in the related art are not described in detail since they would obscure the example embodiments with unnecessary detail.

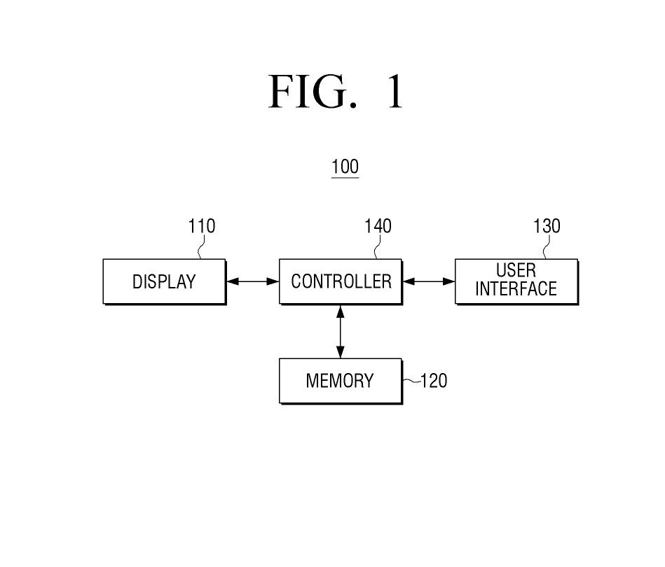

FIG. 1 is a schematic block diagram illustrating a configuration of a display apparatus according to an example embodiment.

The display apparatus according to an example embodiment may be implemented with various display apparatuses which are capable of inputting letters through a handwriting input method or a keyboard input method. The display apparatus may, for example, include a smart phone, a portable terminal, a mobile terminal, a personal digital assistant (PDA), a portable multimedia player (PMP) terminal, a computer, a laptop computer, a note pad, a Wibro terminal, a tablet personal computer (PC), a smart television (TV), or the like.

Referring to FIG. 1, a display apparatus 100 according to an example embodiment may include a display 110, a memory 120, a user interface 130, and a controller 140.

The display 110 may be configured to display information input by the user, for example, via the user interface 130. Specifically, the display 110 may process the input information and display the processed information according to control of the controller 140. The display 110 may be implemented with, for example, a liquid crystal display (LCD), an organic light emitting diode (OLED), and the like, but the display 110 is not limited thereto. A driving circuit which may be implemented in an amorphous silicon (a-Si) thin film transistor (TFT) type, a low temperature polysilicon (LTPS) TFT type, an organic TFT (OTFT) type, and the like, a backlight unit, and the like may be included in the display 110.

The display 110 may display information input through various input methods. The display 110 may display a handwriting input through the handwriting input method and characters input through a keyboard input method.

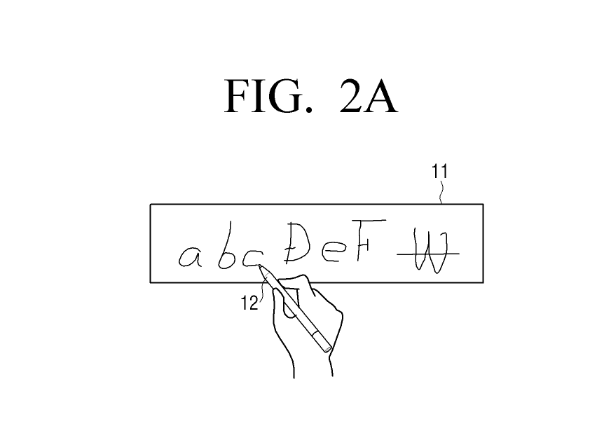

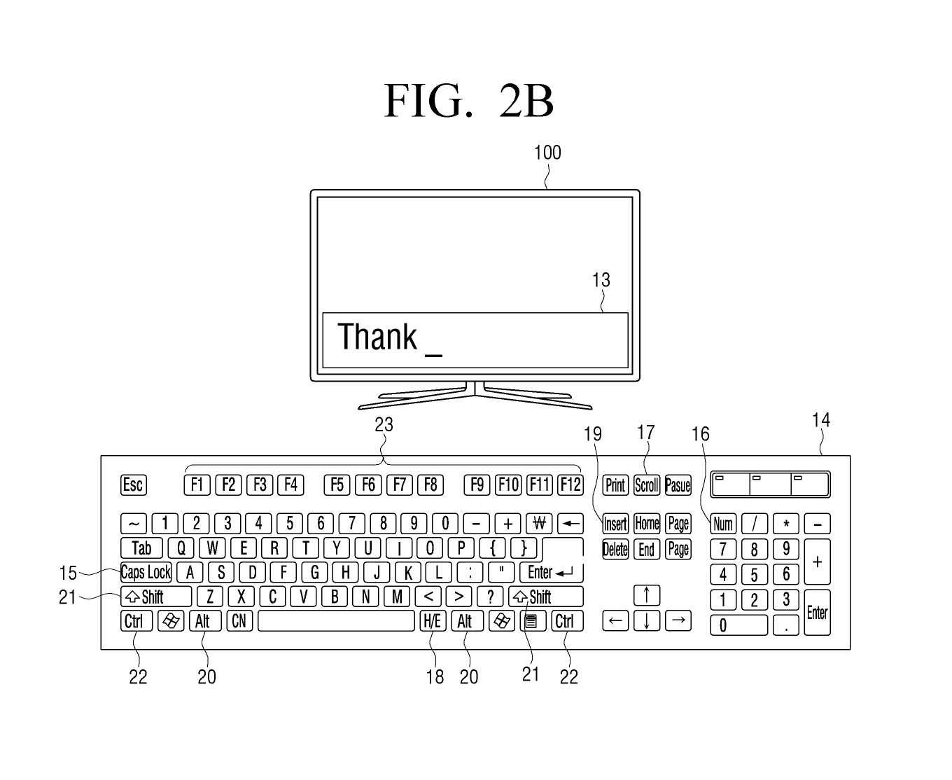

The handwriting input method is a method which inputs characters using, for example, a stylus, an electronic pen or a finger by the user in a manner similar to handwriting and recognizes the handwritten characters. As illustrated in FIG. 2A, the user may input desired information onto a touch screen 11 using an electronic pen 12 in a manner similar to handwriting, and the handwriting input method may be convenient for a user unfamiliar with a keyboard or a keypad.

The keyboard input method inputs a corresponding character by pressing corresponding keys included in a keyboard by the user. As illustrated in FIG. 2B, the user may perform an input according to a desired input method in a text window 13 displayed on the display (see 110 in FIG. 1) using various keys, including, for example, special keys included in a keyboard 14.

In the input of the handwriting input method, the display 110 may intactly output a virtual handwriting action of the user on a touch pad, and the user may confirm the handwriting gesture with the naked eye. The touch pad may be a flat panel including a pressure sensor. In response to the touch pad being touched by a finger or a stylus, an indicator of a screen is moved through pressure detection, and the display apparatus 100 may recognize position information.

The display 110 may be implemented with a touch screen which may also serve as a touch pad. The touch screen may include a position detector which may output coordinates of a touch point in response to the point of the display screen being pressed by a finger or the like. For example, a device in which a display screen may also serve as a touch pad may refer to a touch screen. In response to the handwriting input being directly performed on the touch screen, the handwriting trace may be output onto a position of the touch screen on which the handwriting input is performed.

Hereinafter, for clarity, an example embodiment will be described by assuming that the display 110 is implemented with a touch screen in the handwriting input method. However, the example embodiments are not limited thereto, and a display in which a separate touch pad which may receive the handwriting input may be included in the example embodiments.

The memory 120, e.g., in the form of a memory, may be configured to store the color feedback information for the input objects. The input objects may, for example, refer to a letter, a key input by the user, etc. For example, the input objects may refer to letters of a capital type, a small letter type, a specific symbol type, and the like, a specific letter, a specific special key, and the like. The color feedback information may refer to, in response to an input object being input, information for notifying the user of the input or recognition of the input object through colors set according to the input objects.

In response to letters being input through the handwriting input method, the display apparatus may incorrectly recognize the written letter as other letters due to various writing styles, similar shaped letters, and the like. For example, English alphabet “O” which is input onto the touch screen may be incorrectly recognized number “0”. Small letter English alphabet “I” which is input onto the touch screen may be incorrectly recognized as number “1” or capital English alphabet “I”. In order for the display apparatus to correctly recognize the input letter, the user has to find the incorrectly recognized letter and input the correct letter. However, the user may not easily determine the incorrectly recognized letter among the input letters while handwriting. The user may determine the incorrectly recognized letter after the handwriting input is converted to the corresponding letters, or the operation corresponding to the handwriting input is performed.

In response to letters being input through the keyboard input method, the input based on a desired input method may be performed in the displayed text window 13 on the display 110 using various special keys included in the keyboard 14.

The special keys may include, for example, a toggle key, a combination key, a function key, and the like. The toggle key may include a “Caps Lock” key 15 which converts keys input in small letter English alphabet to letters corresponding capital letter English alphabet, a “Num Lock” key 16 which converts number keys to a numeric mode or a letter mode, a “Scroll Lock” key 17 which activates or inactivates the scroll, a “HAN/ENG” key 18 which converts keys to Korean alphabet keys or English alphabet keys, a “Insert” key 19 which activates/inactivates letter insertion, and the like.

The combination key may include an “Alt” key 20, a “Shift” key 21, a “Ctrl” key 22, and the like which perform special functions, and the like. The function key may be keys which are defined to perform specific functions in computer program and may include “F1 to F12” 23.

For example, in response to capital alphabets being input by the user, the user has to simultaneously press the “Shift” key 21 and a corresponding alphabet key on the keyboard. However, in response to the “Caps Lock” key 15 being input and activated, the user may input a corresponding capital alphabet by pressing the corresponding alphabet key without the pressing of the “Shift” key 21. The User may selectively input English alphabets or Korean alphabets using the “HAN/ENG” key 18.

However, it is difficult to intuitively determine whether and/or which specific special key is input and activated before the user inputs a letter to the text window. In response to undesired special keys being input or in response to desired special keys not being input, other letters which are not intended by the user may be input into the text window, and it may be inconvenient to delete the incorrectly input letters and input the correct letters again.

The inconvenience caused when the user inputs the incorrectly recognized input letters may occur frequently. To remove and/or reduce this convenience, the memory 120 may store color feedback information for providing color feedback which may induce the input intended by the user.

For example, in the handwriting input method, the memory 120 may pre-store input objects to which color feedback information is provided. The input objects may, for example, be letters which may be frequently incorrectly recognized. In response to the stored input object being recognized during handwriting, the user may store the information for providing the color feedback to the user with pre-stored colors for the input objects.

The memory 120 may, for example, store at least one of the color feedback information for letter types and the color feedback information for individual letters. That is, the user may designate and store the specific input objects (capital, special symbol, number, specific letter, specific special key, and the like) for which the color feedback is provided. The user may set and store colors for the pre-stored specific input objects which are notified to the user. For example, the user may designate different colors for the specific input objects and the user may intuitively determine, for example, whether the handwriting input is recognized as capital, the handwriting input is input as a special symbol, and the like.

The letter types may include, for example, a capital type, a small letter type, a number type, a special symbol type, a letter type include dual consonants, and the like. For example, in response to the capital type being stored as the input object by the user in the handwriting input method, the memory 120 may provide color feedback to all capital alphabets A to Z recognized as the input object. The letter type including the dual consonants may refer to all letters including dual consonants (“ [symbol] ”, “ [symbol] ”, and the like) such as “ [symbol] ”, “ [symbol] ”, and the like. For example, “ [symbol] ” in the handwriting input method may be considerably incorrectly recognized as “ [symbol] ” or as other letters not including dual consonants due to the complicate stroke. Therefore, in response to the letter including the dual consonants being recognized, color feedback may be provided to the recognized letter including the dual consonants.

The interface 130 may be configured to receive a user command. The user command may refer to a letter input through the handwriting input method or an input of a specific special key included in a keyboard. In an example embodiment, the user interface 130 in the handwriting input method may be implemented with a device which may receive a handwriting input such as a touch pad. In another example, the user interface 130 may be implemented with a touch screen including a touch pad as in the embodiment. In another example, the user interface 130 in the keyboard input method may be implemented with a physical keyboard which may receive the user input. In response to the keyboard being implemented with a virtual keyboard on a touch screen, the user interface 130 may be the touch screen.

The controller 140 may function to control an overall operation of the display apparatus 100.

The controller 140 may control the display 110 to provide color feedback corresponding to an input object input according to a user command based on the color feedback information stored in the memory 120. For example, in response to a letter type including dual consonants being stored as an input object by the user and “ [symbol] ” being input through the handwriting input method by the user, the display apparatus 100 may correctly recognize “ [symbol] ” and provide color feedback corresponding to “ [symbol] ” to the user. However, the display apparatus 100 may incorrectly recognize “ [symbol] ” as other letters not including dual consonants, and may not provide the color feedback to the user. In this example, in response to the color feedback being provided, the user may determine that the character is recognized as intended through the color feedback. In response to the color feedback being not provided, the user may determine that the character is incorrectly recognized.

In another example, in response to the number type being stored as an input object by the user and capital alphabet “O” being input through the handwriting input method by the user, the display apparatus 100 may correctly recognize capital alphabet “O” and may not provide color feedback corresponding to capital alphabet “O” to the user. The display apparatus 100 may incorrectly recognize capital alphabet “O” as number “0”, and may provide the color feedback corresponding to capital alphabet “O” to the user. In this example, in response to the color feedback being provided, the user may determine that the letter is incorrectly recognized through the color feedback, and in response to the color feedback being not provided, the user may determine that the letter is recognized as intended.

The controller 140 may provide color feedback corresponding to a preset letter which is recognized by the handwriting input onto the displayed handwriting based on the color feedback information stored in the memory 120. That is, the color feedback may be provided to a letter of the displayed handwriting which is recognized as the preset letter. For example, the controller 140 may provide the color feedback to the letter of the displayed handwriting which is recognized as the preset letter through a method of providing a corresponding color with a highlighter effect. In another example, the controller 140 may provide the color feedback through a method of changing a color of the letter itself which is recognized as the preset letter to a color corresponding to the letter.

The user may determine whether the input handwriting is recognized as capital or number by differently storing color feedback information according to preset input objects. For example, in response to a feedback color of capital alphabet “O” being stored in red and a feedback color of number “0” being stored in yellow, the user may intuitively determine whether the handwriting input is recognized as capital letter or a number.

In response to a preset key being input through the character input method using a keyboard, the controller 140 may provide color feedback corresponding to a key input to an input window based on the color feedback information stored in the memory 120. For example, in response to a specific key among keys included in the keyboard being input, the controller may notify the user of the input of the specific key by providing the color feedback information stored corresponding to the specific key. The input of the specific key may refer to the state in which the specific key is pressed and the state in which a function corresponding to the specific key is activated by pressing the specific key. For example, the input of a corresponding key may refer to the state in which the “a” key being pressed or the state in which the “insert” function is activated by pressing the “Insert” key.

The controller 140 may provide the color feedback through a method of changing a color of an input window to a color corresponding to an input special key based on color feedback information corresponding to special keys. That is, the controller 140 may notify the user of whether a special key is pressed or activated by providing the color feedback information by changing the color of the input window to which a letter is input. For example, it may be assumed that the user sets a feedback color of the “Cap Lock” key to light red, and the user creates English text in a small letter. In response to the “Caps Lock” key being activated, the controller 140 may change the color of the input window to which the letter is input to the light red. The user who has seen that the feedback color of the “Caps Lock” key is the light red may recognize the state that the “Caps Lock” key is activated. Therefore, mistyping may be prevented in advance by turning off the capital conversion function of the “Caps Lock” before the letter is input.

In response to a plurality of special keys being simultaneously input, the controller 140 may provide the color feedback through a method of changing the color of the input window to a color determined based on the priority set to the plurality of special keys. For example, it may be assumed that a plurality of special keys of which feedback colors have been stored are simultaneously input. The priority may be set to the plurality of special keys. The priority may, for example, be set in order of special keys having high typing error possibility, in order of special keys having large usage, and the like. In this example, the controller 140 may change the color of the input window to a feedback color corresponding to a special key having the highest priority among the plurality of input special keys. In response to the input of the special key having the highest priority, the controller 140 may change the color of the input window to a feedback color corresponding to a special key having the second highest priority among the activated special keys again.

In another example, in response to a plurality of special keys being simultaneously input, the controller 140 may provide color feedback through a method of alternately changing the color of the input window to colors corresponding to the plurality of special keys. For example, in response to the “Caps Lock” key of which the feedback color is stored in “light blue” and the “Insert” key of which the feedback color is stored in “light yellow” being simultaneously input, the controller 140 may alternately change the color of the input window to “light blue” and “light yellow”. In this example, in response to the input of the “Caps Lock” key being completed, the controller 140 may fix the color of the input window to “light yellow”.

In another example, the controller 140 may provide a user interface (UI) for selecting an input object and a feedback color according to a preset event, and store an input object selected on the UI according to a user command and a color corresponding to the selected input object as color feedback information corresponding to the selected input object. The UI for selecting the input object and feedback color may be provided in a form of a user setup screen. The preset event may refer to various operations on the user interface 130 including a touch input, a mouse click, a keyboard input, and the like for entering the user setup screen. The controller 140 may intuitively provide the information for recognition/input of a specific input object to the user through a simple setup on the UI, and the controller 140 may induce the user to correctly input intended letters.

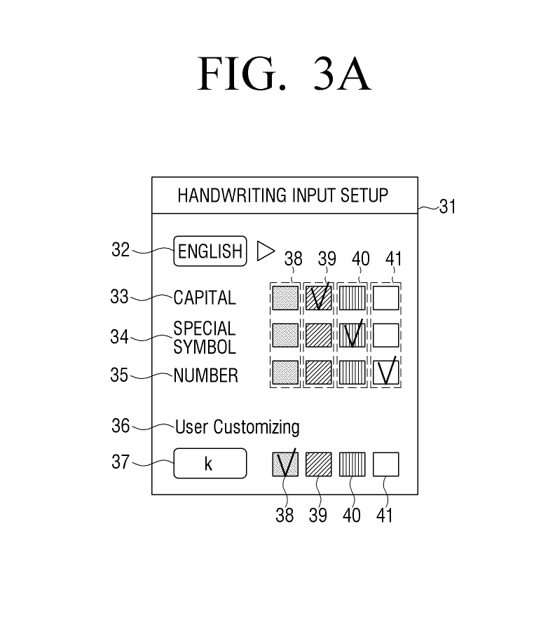

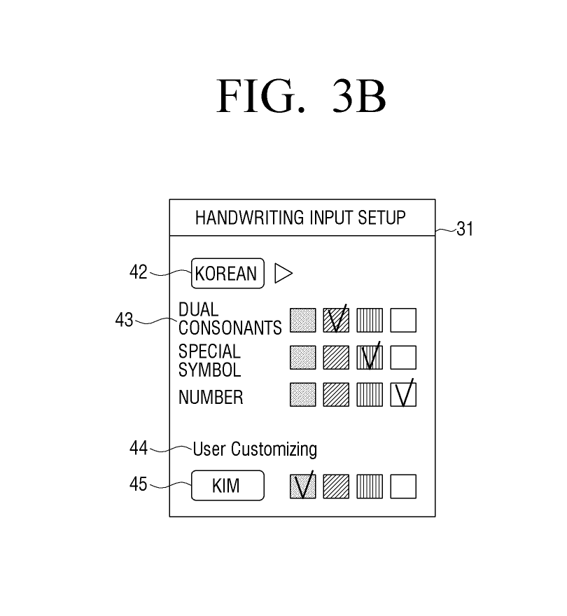

FIGS. 3A and 3B are diagrams illustrating a method of storing color feedback information for input objects according to an example embodiment.

FIG. 3A illustrates a UI screen for storing color feedback information in response to an input being performed in English through the handwriting input method. Referring to FIG. 3A, a UI screen 31 may include a language setup region 32 for setting an language, a color setup region for setting various colors 38, 39, 40, and 41 corresponding to letter types including a capital type 33, a special symbol type 34, and a number type 35, and a user customizing region 36 for directly designating a specific alphabet 37 and colors 38 to 41 corresponding thereto by the user. The user may change the language to a language of a country to be set by pressing the language setup region 32.

The user may set and store color feedback corresponding to the capital type 33 through a method of checking any one color 39 among the colors 38 to 41 of the capital type 33. The user may designate a plurality of alphabets in the user customizing region 36, and may additionally designate an alphabet by selecting an alphabet input region 37.

FIG. 3B illustrates a UI screen for storing color feedback information in response to an input being performed in Hangul through the handwriting input method. Referring to FIG. 3B, a UI screen 31 may include a language setup region 42 for setting an language, a color setup region in which the capital type in the English input is changed to a dual consonants type 43, and a user customizing region 44.

The user may set and store color feedback corresponding to all letter types including dual consonants through a method of checking any one color among colors of the dual consonants type 43. The user may designate a plurality of Hangul syllables in the user customizing region 44, and may additionally designate a Hangul syllable by selecting a syllable input region 45.

In an example embodiment, the color selection method is not limited to the color selection method illustrated in FIGS. 3A and 3B. More colors may be designated through various color selection methods, for example, using a color palette, and the like.

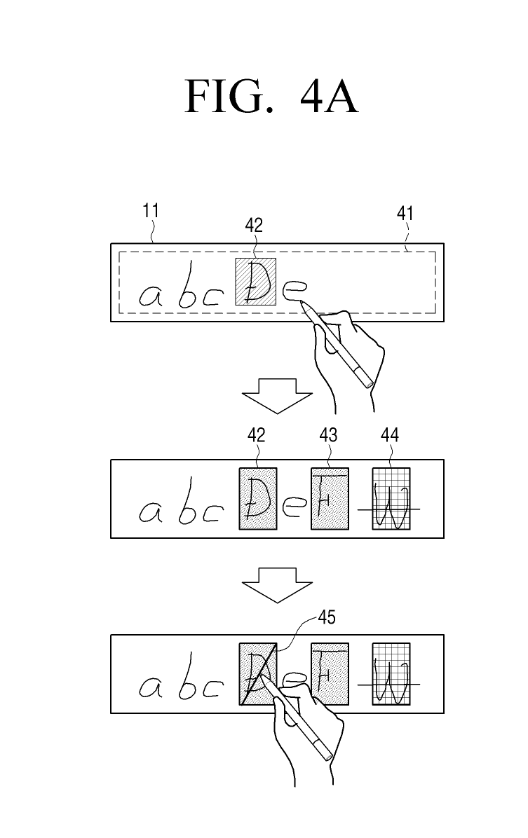

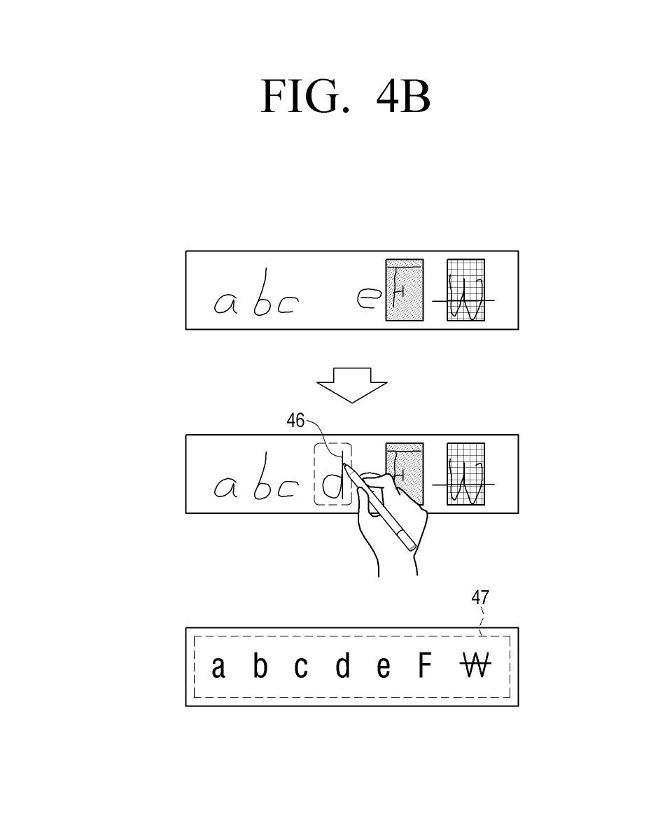

FIGS. 4A and 4B are diagrams illustrating a method of providing color feedback on a displayed handwriting according to an example embodiment.

As illustrated in FIG. 4A, in response to a character to be input by the user being “abcdeF [symbol] ”, the user may input the corresponding character to the display 110 which is implemented with a touch screen in a handwriting area 41. For example, it may be assumed that the user set a capital type and a specific symbol type as input objects and store color feedback information for the input objects in advance. In response to the handwriting 41 being input, the controller 140 may recognize the input handwriting. The controller 140 may recognize “d” 42 and “F” 43 among the input handwriting 41 as capitals, and recognize “ [symbol] ” 44 as a specific symbol. In this example, the controller 140 may provide the color feedback information by applying a highlighter effect to handwriting regions corresponding to the letters recognized as the capitals and special symbol. The highlighter effect may refer to color feedback which changes colors of the certain handwriting regions including the letters recognized as the capitals and special symbol to be distinguished from colors of handwriting regions including the other letters. The user may intuitively recognize that “d” among the letters “D” 42, “F” 43, and “ [symbol] ” 44 to which the highlighter effect is applied is incorrectly recognized as capital. Therefore, the user may delete the incorrectly recognized letter “D” 42 through various methods, for example, a method of drawing an oblique line 45 on the handwriting region corresponding to the incorrectly recognized letter “D” 42.

As illustrated in FIG. 4B, in response to the incorrectly recognized letter “D” 42 being deleted by the user, the user may input the correct letter “d” 46 in a position in which the incorrectly recognized letter “D” 42 is deleted again. In response to re-input of the correct letter “d” being completed, the display apparatus 100 may recognize the character “abcdeFY” intended by the user and may finally display a handwriting 47 as recognition result.

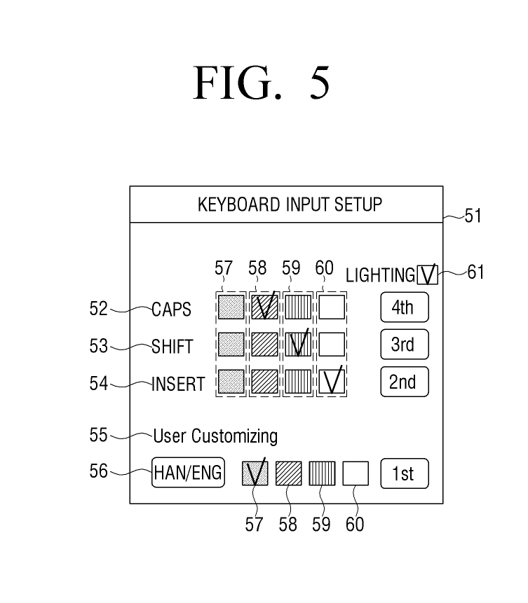

FIG. 5 is a diagram illustrating a method of storing color feedback information for input objects according to another example embodiment.

Referring to FIG. 5, in response to a character being input using the keyboard input method, a UI screen for storing color feedback information may be provided. A UI screen 51 may, for example, include a color setup region for setting various colors 57, 58, 59, and 60 corresponding, for example, to a “Caps Lock” key 52, a “Shift” key 53, and an “Insert” key 54, a user customizing region 55 for directly designating specific special keys and the colors 57 to 60 corresponding thereto by the user, and a color feedback selection region for selecting a color feedback providing method in response to a plurality of special keys being simultaneously input.

The user may set and store color feedback corresponding to the “Caps Lock” key 52 through a method of checking, for example, any one color 58 among the colors 57 to 60 of the “Caps Lock” key 52. The user may designate a plurality of specific special keys in the user customizing region 55, and may additionally designate a specific special key by selecting a special key input region 56.

In an example embodiment, the color feedback selection region may be implemented with a lighting selection region 61. In response to a plurality of special keys being simultaneously input in the state that the lighting selection region 61 is checked, the controller 140 may alternately change the color of the input window to colors corresponding to the plurality of special keys. In response to the plurality of special keys being simultaneously input in the state that the lighting selection region 61 being not checked, the controller 140 may change the color of the input window to a color determined based on a priority set to the plurality of special keys. The UI screen 51 may further include a priority setup region (not shown) for setting the priority for the plurality of special keys.

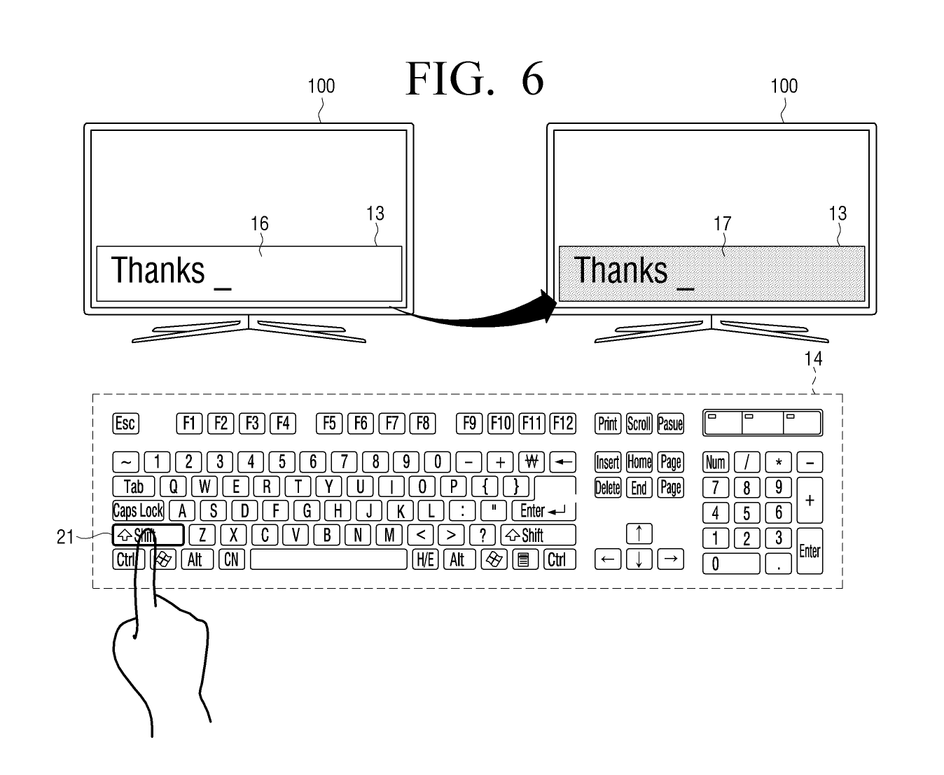

FIG. 6 is a diagram illustrating a method of providing color feedback to a displayed input window according to an example embodiment.

In response to a character input by the user being “Thanks!”, the user may input corresponding keys in an input window displayed on the display through the character input method using a keyboard 14. For example, it may be assumed that the user sets the “Shift” key 21 to an input object and set the feedback color of the “Shift” key 21 to light blue in advance. The user may input the exclamation mark “!” by pressing the number 1 key in the state that the “Shift” key 21 is pressed. In response to the “Shift” key 21 being pressed by the user, the controller 140 may read out color feedback information corresponding to the “Shift” key 21 from the memory 120 and change the color of the input window 13 to light blue 17 from existing white 13.

The user may intuitively recognize the state that the “Shift” key 21 is pressed through the changed color of the input window. Therefore, the user may determine whether or not a specific key is input before the user inputs a letter, and the mistyping due to the input of the special key may be reduced.

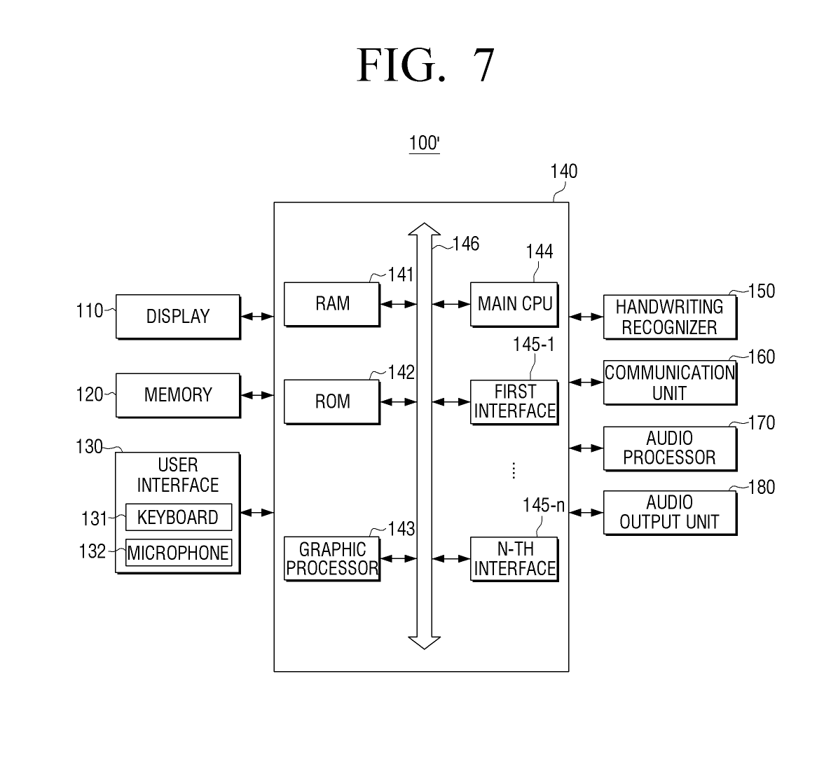

FIG. 7 is a detailed block diagram illustrating a configuration of a display apparatus according to another example embodiment. As illustrated in FIG. 7, a display apparatus 100′ according to another example embodiment may include, for example, a display 110, a memory 120, a user interface 130, a handwriting recognizer 150, a communication unit 160, an audio processor 170, and an audio output unit 180. Hereinafter, description for a portion of the display apparatus 100′ overlapping the display apparatus 100 in FIG. 1 will be omitted.

The user interface 130 may be configured to receive a user input for controlling an overall operation of the display apparatus 100′. The user interface 130 may include various input devices such as, for example, a keyboard 131 and a microphone 132 as illustrated in FIG. 7. The keyboard 131 may be configured to input a letter by the user through the keyboard input method, and may be implemented with a physical keyboard. However, the keyboard 131 is not limited thereto, and may, for example, be implemented with a virtual keyboard on a touch screen. The display apparatus 100′ may receive the user's voice through the microphone 132, and may recognize letters corresponding to the user's voice. The display apparatus 100′ may provide color feedback corresponding to the recognized letters.

In response to the display 110 being implemented with a touch screen which also serves as a touch pad in the handwriting input method, the user interface 130 may be configured to be included in the display 110.

The controller 140 may include a random access memory (RAM) 141, a read only memory (ROM) 142, a graphic processor 143, a main central processing unit (CPU) 144, first and n-th interfaces 145-1 to 145-n, and a bus 146. The RAM 141, the ROM 142, the graphic processor 143, the main CPU 144, the first to n-th interfaces 145-1 to 145-n, and the like may be coupled to each other through the bus 146.

A command set for booting and the like may be stored in the ROM 142. The main CPU 144 may copy various application programs stored in the memory 120 to the RAM 141, and perform various operations by executing the application programs copied in the RAM 141.

The graphic processor 143 may generate a screen including various objects such as, for example, an icon, an image, text, and the like using an operation unit (not shown) and a rendering unit (not shown). The operation unit may calculate attribute values such as coordinate values in which the objects are to be displayed, shapes, sizes, and colors of the objects, and the like according to a layout of the screen. The rendering unit may generate various layouts of screens including objects based on the attribute value calculated in the operation unit.

The main CPU 144 may access the memory 120, and perform booting using an operating system (OS) stored in the memory 120. The main CPU 144 may perform various operations using various programs, content, data, and the like stored in the memory 120.

The first to n-th interfaces 145-1 to 145-n may be coupled to the above-described configuration components. One of the interfaces may, for example, be a network interface coupled to an external apparatus through a network.

The handwriting recognizer 150 may recognize the writing style of the user using any one of a resistive method (press sensing method) which detects a finger, a stylus, a general pen, an electronic and the like, a capacitance method which detects a finger, an infrared method, an ultrasonic method, and any combination thereof. However, the handwriting recognition method is not limited thereto, and the handwriting may be recognized through various methods which may detect a handwriting gesture.

The communication unit 160 may be configured to perform communication with various types of external apparatuses or external servers according to various types of communication methods. The communication unit 160 may include various communication chips such as, for example, a WiFi chip, a Bluethooth chip, a near field communication (NFC) chip, or a wireless communication chip, or the like.

The audio processor 170 may be configured to perform processing on audio data. The audio processor 170 may perform various processing operations such as, for example, decoding, amplification, and noise filtering on the audio data.

The audio output unit 180 may be configured to output a variety of data processed in the audio processor 170 as well as various alarm sounds and/or voice messages. The audio output unit 180 may be implemented with a speaker. However, this is merely exemplary, and the audio output unit 180 may be implemented with other audio output units such as audio output terminals.

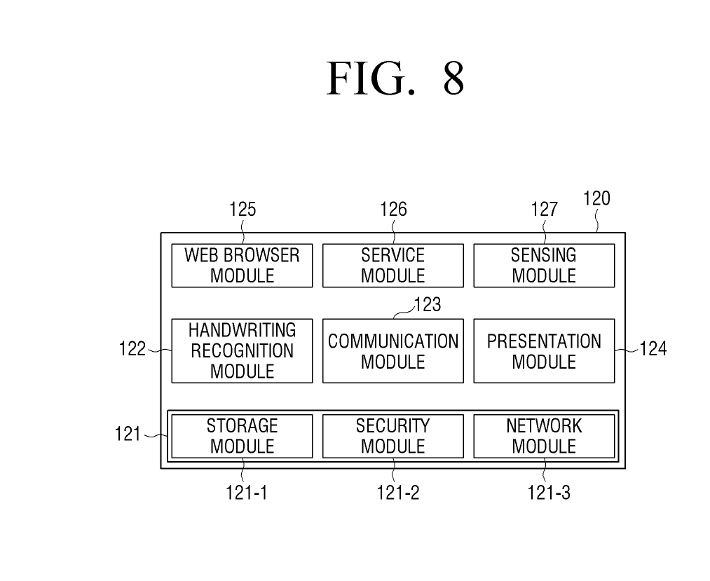

The memory 120 may store color feedback information for input objects, and may store various modules for driving the display apparatus 100′. The configuration of the memory 120 will be described with reference to FIG. 8.

FIG. 8 is a detailed block diagram illustrating a configuration of a memory according to an example embodiment.

Referring to FIG. 8, the memory 120 may, for example, store software including a base module 121, a handwriting recognition module 122, a communication module 123, a presentation module 124, a web browser module 124, a service module 126, and a sensing module 126.

The base module 121 may, for example, refer to a basic module which processes signals transmitted from hardware included in the display apparatus 100′ and transmits the processed signals to an upper layer module.

A storage module 121-1 may, for example, be a program module which manages a data base DB, a registry, and the like. A security module 121-2 may be a program module which supports certification, permission, secure storage, and the like for hardware. A network module 121-3 may be a module which supports network connection.

The handwriting recognition module 122 may be configured to extract letters from a handwriting input. The handwriting recognition module 122 may extract various letters including letters of countries such as Hangul or Alphabet, number, a special letter, a space, and the like from the handwriting input. The handwriting recognition module 122 may recognize and extract the letters using pattern matching, structure analysis, and the like.

The communication module 123 may be a module which performs communication with the outside. The communication module 123 may include a messaging module and a phone module.

The presentation module 124 may be a module which forms a display screen. The presentation module 124 may, for example, include a multimedia module which reproduces multimedia content and outputs the reproduced content, and a UI rendering module which performs UI and graphic processing.

The web browser module 125 may refer to a module which performs web browsing and accesses a web server.

The service module 126 may be a module including various applications for providing a variety of services. The service module 126 may include various program modules such as social network service (SNS) program or content reproduction program.

The sensing module 127 may be a module which collects information from various sensors, and analyzes and manages the collected information.

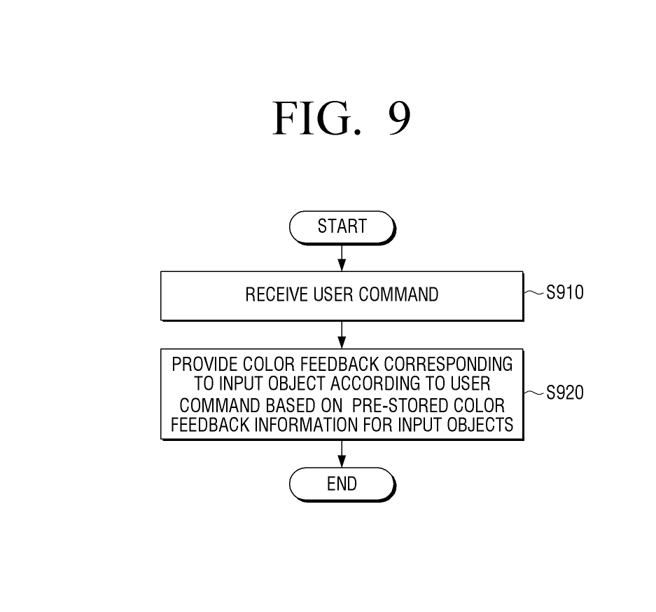

FIG. 9 is a flowchart illustrating a control method of a display apparatus according to an example embodiment.

The display apparatus may store color feedback information for input objects. The display apparatus may, for example, store at least one of color feedback information for letter types of the input objects and color feedback information for individual letters. The display apparatus 100 may receive a user command (S910). For example, in response to the user command being received through a handwriting input, the display apparatus may display the input handwriting. In response to the user command being received, the display apparatus may provide color feedback corresponding to an input object input according to the user command based on the stored color feedback information through a display (S920). The display apparatus may provide color feedback corresponding to a preset letter recognized through the handwriting input onto a display handwriting based on the stored color feedback information. In another example, in response to the user command being received through a keyboard input, the display apparatus may receive a preset key and provide color feedback corresponding to the key input to an input window based on the stored color feedback information. In this example, the preset key may include at least one of special keys provided in a keyboard. The display apparatus may change a color of the input window to a color corresponding to the input special key based on color feedback information corresponding to the special keys.

The control method of a display apparatus according to example embodiments may be implemented in program and provided to display apparatuses.

As an example, a non-transitory computer-readable medium, in which program for executing the operations of storing color feedback information for input objects, receiving a user command, and providing color feedback corresponding to an input object input according to the user command based on the stored color feedback information through a display in response to the user command being received is stored, may be provided.

The non-transitory computer-readable medium is not a medium configured to temporarily store data such as a register, a cache, or a memory but an apparatus-readable medium configured to permanently or semi-permanently store data. For example, the above-described various application or programs may be stored in the non-transitory apparatus-readable medium such as a compact disc (CD), a digital versatile disc (DVD), a hard disc, a Blu-ray disc, a universal serial bus (USB), a memory card, a ROM, or the like.

The foregoing example embodiments and advantages are described merely for purposes of example and are not to be construed as limiting. The example embodiments can be readily applied to other types of devices. Also, the description of the example embodiments is intended to be illustrative only, and not to limit the scope of the claims, and many alternatives, modifications, and variations will be apparent to those skilled in the art.

What is claimed is:

1. A display apparatus comprising:
a display;
a memory configured to store color feedback information for input objects;
a user interface configured to receive a user command; and
a controller configured to control the display to provide color feedback corresponding to an input object based on the color feedback information stored in the memory.

2. The display apparatus as claimed in claim 1, wherein the memory is configured to store at least one of color feedback information for letter types and color feedback information for individual letters.

3. The display apparatus as claimed in claim 2, wherein the letter types include at least one of a capital type, a small letter type, a number type, a special symbol type, and a letter type including double consonants.

4. The display apparatus as claimed in claim 2, wherein, the display is configured to display an input handwriting when a handwriting input is received, and the controller is configured to provide color feedback corresponding to a preset letter recognized by the handwriting input on the displayed handwriting based on the color feedback information stored in the memory.

5. The display apparatus as claimed in claim 4, wherein the controller is configured to provide a color corresponding to the preset letter to the displayed handwriting with a highlighter effect.

6. The display apparatus as claimed in claim 1, wherein the display is configured to display an input window, and the controller is configured to provide color feedback corresponding to a preset key input to the input window based on the color feedback information stored in the memory.

7. The display apparatus as claimed in claim 6, wherein the preset key includes at least one among special keys included on a keyboard, and the controller is configured to provide the color feedback by changing a color of the input window to a color corresponding to the preset key based on color feedback information corresponding to the special keys.

8. The display apparatus as claimed in claim 7, wherein the controller is configured to provide color feedback by changing a color of the input window to a color determined based on a priority set to a plurality of special keys when a plurality of special keys are simultaneously active.

9. The display apparatus as claimed in claim 7, wherein the controller is configured to provide color feedback by alternately changing a color of the input window to colors corresponding to a plurality of special keys when a plurality of special keys are simultaneously active.

10. The display apparatus as claimed in claim 1, wherein the controller is configured to provide a user interface (UI) for enabling selection of an input object and a feedback color according to a preset event, and is configured to store an input object selected on the UI and a color corresponding to the selected input object as color feedback information corresponding to the selected object.

11. A method of controlling a display apparatus, the method comprising:
receiving a user command; and
providing color feedback corresponding to an input object according to the user command based on color feedback information pre-stored according to input objects.

12. The method as claimed in claim 11, wherein the color feedback information pre-stored according to the input objects includes at least one of color feedback information for letter types and color feedback information for individual letters.

13. The method as claimed in claim 12, wherein the letter types include at least one of a capital type, a small letter type, a number type, a special symbol type, and a letter type including double consonants.

14. The method as claimed in claim 12, further comprising displaying a handwriting input,
wherein the providing of the color feedback includes providing color feedback corresponding to a preset letter recognized by the handwriting input on the displayed handwriting based on the pre-stored color feedback information.

15. The method as claimed in claim 14, wherein the providing of the color feedback includes providing a color corresponding to the preset letter to the displayed handwriting with a highlighter effect.

16. The method as claimed in claim 11, further comprising displaying an input window,
wherein the providing of the color feedback includes providing color feedback corresponding to a preset key input to the input window based on the pre-stored color feedback information.

17. The method as claimed in claim 16, wherein the preset key includes at least of a plurality of special keys included on a keyboard, and the providing of the color feedback includes providing the color feedback by changing a color of the input window to a color corresponding to the input special key based on color feedback information corresponding to the special keys.

18. The method as claimed in claim 17, wherein the providing of the color feedback includes providing the color feedback by changing a color of the input window to a color determined based on a priority set to a plurality of special keys when a plurality of special keys are simultaneously active.

19. The method as claimed in claim 17, wherein the providing of the color feedback includes providing the color feedback by alternately changing a color of the input window to colors corresponding to a plurality of special keys when a plurality of special keys are simultaneously active.

20. The method as claimed in claim 11, further comprising:
providing a user interface (UI) enabling selection of an input object and a feedback color according to a preset event; and
storing an input object selected on the UI and a color corresponding to the selected input object as color feedback information corresponding to the selected object.
